(19) United States
(12) Patent Application Publication
(10) Pub. No.: US 2012/0036424 A1
(43) Pub. Date: Feb. 9, 2012

(54) Method and system for receiving and displaying information

(76) Inventor: Steven Stavros Prast, Rochester Hills, MI (US)

(21) Appl. No.: 12/806,156

(22) Filed: Aug. 6, 2010

(51) Int. Cl. G06F 17/00

(52) U.S. Cl. 715/234

(57) ABSTRACT

A system 40 which separately extracts geometric data 12 and metadata 14 from a CAD environment and places them in a PDF environment 20.

### GENERAL BACKGROUND

1. Field of the Invention

The present invention generally relates to a method and a system for receiving and displaying information and more particularly, to a system and a method for receiving geometric and metadata or textual information (or allowing such information to be selectively created) in a first format, and which later displays at least a portion of the geometric information in a second format along with a predetermined portion of the received or existing metadata information, and to a system which provides such desired functionality.

2. Background of the Invention

Geometric and metadata information are often expressed within a conventional computer aided design format or system, and such a system (e.g. often referred to as a “CAD” system and/or a “CAD” environment) typically provides detailed geometric and textual information about a physical object and/or process. While such a CAD type expression is very useful, such as in an overall design or optimization process, the amount of data resident within such a CAD type expression limits its practical usefulness to activities requiring a rather lengthy amount of analysis and to advanced computer systems having relatively advanced and relatively costly processing assemblies.

It is known to express geometric information in a Portable Data Format (e.g., often referred to as a “PDF” format) and such a format purposefully allows for only a limited amount of such geometric data to be utilized. While such a PDF format may not contain all of the geometric data and none of the textual or metadata found in the CAD expression, it is rather efficient and fast to process and allows a user to gain information and conduct a relatively limited analysis in a relative quick manner, without requiring relatively advanced and costly computer systems. An expression of geometric data from a CAD type format to a PDF type format may be achieved by a translator which is currently provided by Adobe Systems, Inc of San Jose, Calif. (hereinafter sometimes referred to as “Adobe”)

Which the foregoing PDF expression of geometric is useful, it does not provide for an expression or display of any of the metadata information contained in the CAD format and this drawback has really limited the usefulness of the PDF translator and the overall created expression because the metadata or textual information allows a user to gain additional information, in a very efficient manner, about the geometric expression.

There is therefore a need to allow for the translation of both geometric and metadata information expressed in a CAD format to a PDF format and it is principle and non-limiting object of the present inventions to provide for such a desired translation.

### SUMMARY OF THE INVENTION

It is a first non-limiting object of the present inventions to provide a method for receiving (or allowing the selective creation) of both geometric and metadata information which are expressed in a CAD format and to allow at least some of the receive information to be expressed and displayed in a PDF format.

It is a second non-limiting object of the present invention to provide a system which allows for the selective translation of geometric and metadata which are expressed in a CAD type format, to a PDF type format.

According to a first non-limiting aspect of the present invention, a method for receiving and displaying information is provided and includes the steps of receiving geometric and metadata information in a Computer Aided Design format; displaying at least a portion of the received geometric information in a Portable Data Format; preselecting a portion of the received metadata information; and displaying only the preselected portion of the received metadata information within the Portable Data Format.

According to a second non-limiting aspect of the present invention, a system is provided which receives geometric and metadata information expressed in a Computer Aided Design format and which allows at least some of the received metadata information to be displayed in a Portable Data Format.

According to a third non-limiting aspect of the present invention, a system is provided and which receives geometric and textual information expressed in a Computer Aided Design format and which expresses the geometric information in a Portable Data Format and which further displays a preselected amount of said received textual information in the Portable Data Format.

These and other features, aspects, and advantages of the present invention will become apparent from a reading of the following detailed description of the preferred embodiment of the invention, including the subjoined claims, and by reference to the following drawings.

### BRIEF DESCRIPTION OF THE DRAWINGS

FIG. 1 is a block diagram of the methodology of the preferred embodiment of the invention.

FIG. 2 is a block diagram of a computer system which is made in accordance with the teachings of the preferred embodiment of the invention and which selectively performs the methodology of the various inventions.

FIG. 3 is a display of visual and metadata information according to the teachings of the preferred embodiment of the invention.

### DETAILED DESCRIPTION OF THE PREFERRED EMBODIMENT OF THE INVENTION

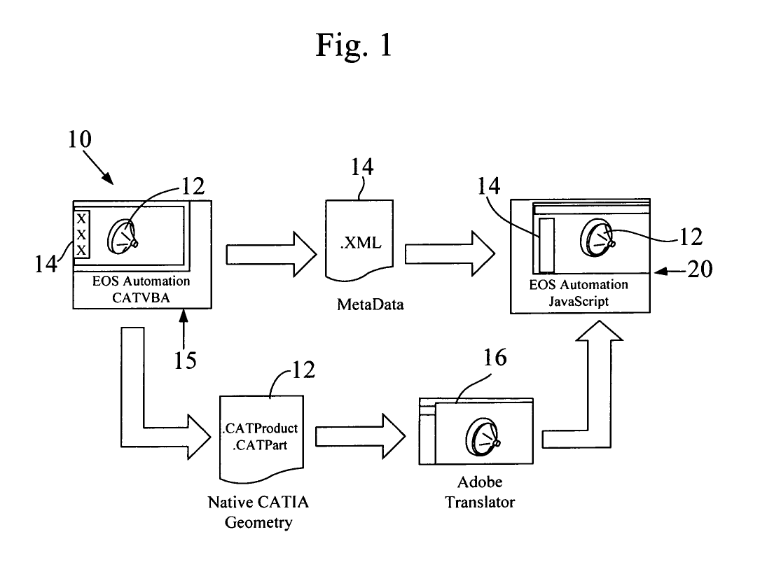

Referring now to FIG. 1, there is shown a block diagram 10 which illustrates the methodology of the preferred embodiment of the invention.

Particularly, methodology 10 begins with geometric data 12 and metadata 14 being expressed in a CAD environment 15, such as that which is provided by the CATIA® system. The geometric data 12 is communicated, in a known manner, to a translator 16 which may be provided by ADOBE. Such geometric data 12 may comprise, by way of example and without limitation, “CAT Product” and/or. “CAT part” type files. Other proprietary computer aided files may also be utilized. These proprietary computer aided design files will define the visual appearance of the object(s) to which they respectively pertain. Some of the geometric data 12 may thereafter be expressed in a PDF environment or format 20. According to the teachings of the preferred embodiment of the invention, at least some of the metadata 16 is extracted from the CAD environment 15 and communicated to the PDF environment 20 as. “xml” type files, where the extracted metadata 16 is displayed in combination with the geometric data 12 which has been expressed in the PDF format. Thus, as shown perhaps best in FIG. 3, a display 24 may have both geometric information 30 and metadata 34 which have each been selectively and previously extracted from the CAD environment 15 and now are expressed within a PDF environment. It should be appreciated that nothing in this description is meant to limit the present invention to a particular type or amount of geometric data or to a particular type of metadata and that the geometric data may represent substantially any tangible entity and the metadata may represent any type of textual or explanatory data.

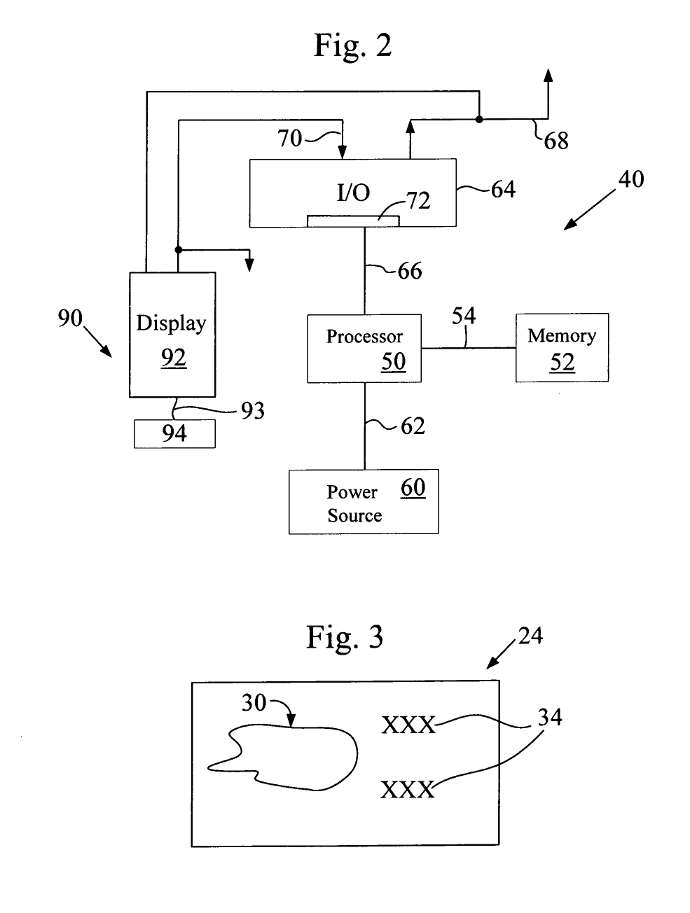

One non-limiting example of a computer system to provide the foregoing desired functionality is represented as system 40 and is shown in FIG. 2. Particularly, system 40 includes a processor 50 which is operable under stored program control and a memory assembly 52 which is physically and communicatively coupled to the processor 50 by a bus 54. The memory assembly 52 is adapted to contain the code necessary to instruct/cause the processor 50 to perform the various functions necessary to achieve the desired and previously described operations The system 40 further includes a source of electrical power 60, such as an electrical battery, which is coupled to the processor 50 by the bus 62 and which provides operating energy to the processor 50 and to various other portions of the system 40 which may selectively receive such provided energy through the processor 50. The system 40 further includes an input/output portion 64 which is coupled to the processor 50 by the bus 66 and which is further coupled to output bus 68 and an input bus 70.

Particularly, the input/output portion 64 may include a modulator/demodulator 72 and receives information which has been previously placed upon bus 70 and may demodulate this received information before communicating such information to the processor 50, by use of the bus 66. The input/output portion 64 may receive information from the processor 50, by use of the bus 66, and may modulate this information before placing such previously received and potentially modulated information onto the output bus 68 where such information may be communicated to some desired entity.

The system 40 may also include a display assembly 90 which may include the combination of a display portion 92 (which may be substantially similar to display 2) and a keyboard 94 which may be physically and communicatively coupled to the display portion 92 by use of the bus 93. Keyboard 94 may additionally or alternatively be physically and communicatively coupled to the processor 50 directly. The assembly 90 is physically and communicatively coupled to the busses 68, 70 and the display portion 92 may selectively receive and display information from the processor 50 and the keyboard portion 94 may be used to generate information which is communicated to the processor 50 and which may be displayed upon the display portion 92.

It should be appreciated that the foregoing system 40 is just one non-limiting example of a system which may be used to perform the desired functionality associated with the various inventions.

In operation, the CAD environment 15 may either reside within system 40 (e.g., within the combination of the processor 50 and memory 52) or be communicatively coupled to the processor 50 by use of the busses 68, 70 and the input/output portion 64. That is, the CAD operating system may reside within memory assembly 52, thereby allowing the CAD environment containing information 12, 14 to be created within system 40, or reside in another system which is separate and distinct from system 40. The processor 50, acting under the direction and the control of the programming rules or code which is resident within the memory assembly 52, identifies the generic data 12 (by file type) and then takes the identified geometric data 12 and communicates such data to a translator 16 which may be resident within the system 40 or external to the system 40. If the translator 16 is remote from the system 40, then the identified and extracted geometric data 12 is communicated to the translator 16 through the input/output portion 64 and busses 66 and 68. The processor 50 also identifies (by file type) and takes at least some of the metadata 16, which is resident within the CAD environment 15, and transports such metadata to the PDF environment 20 where it is joined with the output data emanating from the translator 20. The display 92 may, in one non-limiting embodiment, function as display 24.

In one non-limiting embodiment the following metadata is identified and extracted by the processor 50

### (A) 3D Integration Nomenclature

Nomenclature is the set of information used to identifying and classifying a part or an assembly. This includes its common name (Piston, Power Coupling, Pump, etc), its unique part/assembly number, its revision letter and even its configuration. Nomenclature often includes where used information such parent assembly. In addition, release state (in-process, released, obsolete, etc.) is also often included in Nomenclature. On a traditional engineering drawing, the Nomenclature typically comprises the title block of the drawing.

### (B) Bill of Material

The Bill of Material is a list of component parts and other materials required to form an assembly. This includes not only engineered parts but also consumables such as grease. Quantities and a subset of nomenclature for each item in the Bill of Material is often included. Recently, material size has been added to many Bills of Material used in the aerospace industry to control the amount of stock material used in manufacturing to help control costs and improve material consistency.

### (C) System Attributes

System Attributes are attributes assigned to a part or an assembly by a CAD software application. The attributes are automatically added by the CAD application by default. These attributes are used by the CAD application for a variety of functions. While all CAD applications have their own unique set of system attributes and unique methods for handling those attributes, there some System Attributes common to all CAD applications. One example is the Universal Unique Identifier or (UUID). The UUID is used to tell one unique part from another and to track the lifecycle of that part through modifications.

### (D) User Attributes

User Attributes are attributes assigned to a part or an assembly in a CAD software application as defined by the organization using that CAD application. This feature is commonly used to store information unique to a given organization. For example, even though Boeing and Ford both use the Dassault Systemes CATIA CAD application, they each have their own set of unique User Attributes defined to meet the requirements of designing aircraft and automobiles respectively.

### (E) Materials

Materials are a set of information within a CAD software application that defines the raw substances that constitute a part. For example, a Material for 8020 Aluminum can be defined within a CAD application that includes the density, specific gravity and other unique characteristics for that aluminum alloy. That Material can then be assigned to a part to define the raw material used to manufacture that part. Most CAD software applications offer a catalog feature to store materials used across all parts designed by a single organization.

### (F) Mechanical Properties

Mechanical Properties are a set of attributes derived from the geometry and material of a part or assembly. The Center of Gravity and Moment of Inertia are two examples Mechanical Properties calculated by using a part or assemblies volume, shape and density. Most CAD software applications calculate Mechanical Properties automatically as the part or assembly is created or modified.

### (G) Feature Definition

A Feature is a geometric element in 3D CAD model such as a cylinder, a hole or a fillet. The Feature Definition are the unique properties and values that literally create the feature. For example, a hole will have a Feature Definition that includes the type of hole (blind, up to a surface, etc.) the diameter, the depth if applicable and if the hole has a counter sink.

### (H) GD&T Definition (Called FTA Definition for the Dassault Systemes CATIA CAD Software Application)

GD&T stands for Geometric Dimensioning and Tolerance. This is the set of information that defines the actual measurements of the geometry of a 3D CAD model as well the manufacturing tolerance for those measurements. Examples of GD&T include length, radius, surface finish (roughness), heat treat and even color.

### (I) GD&T References (Called FTA References for the Dassault Systemes CATIA CAD Software Application)

GD&T References is a link between a GD&T element and the geometric feature that it is representing. For example, GD&T element for a diameter measurement may be linked to a hole feature in a 3D CAD model. This link is used to relate the GD&T element to the geometric feature for tracking an change management purposes.

### (J) Kinematic Device Definition

Kinematic Device Definition is a set of properties within a 3D CAD model that define how an assembly is mechanically articulated. For example, the Kinematic Device Definition for a piston assembly would include of stroke for the piston defined as the length of the stroke (how far the piston moves in 3D space) and the axis of movement (the direction the piston moves). Kinematic Device Definition is used by 3D CAD software applications and other 3D analysis applications to perform function or operational simulations of assemblies.

### (K) Mechanical Simulations (Called DMU/DELMIA Simulations for the Assault Systems Catia CAD Software Application)

Mechanical Simulations are dynamic representations of operations involving 3d CAD models. These simulations could be of the function of an assembly, the manufacturing process of a part or an assembly or even maintenance activities involving a part or assembly.

It is to be understood that the various inventions are not limited by the exact construction or methodology which has been delineated above, but that various changes and modifications may be made without departing from the spirit and the scope of these various inventions as they may be delineated in the following claims. Thus, from the foregoing it should be appreciated that the various inventions allow both geometric and metadata which is initially expressed within a CAD type format to be expressed in a CAD format.

What Is Claimed:

1. A method for receiving and displaying information comprising the steps of receiving geometric and metadata information in a computer aided design format; displaying at least a portion of said received geometric information in a portable data format; preselecting a portion of said received metadata information; and displaying only said preselected portion of said received metadata information within said Portable Data Format.

2. The method of claim 1 wherein said preselected portion of said received metadata information comprises nomenclature; bill of material; system attributes; user attributes; and material textual information.

3. The method of claim 2 wherein said preselected portion of said received metadata information further comprises feature definition; FTA definition; and kinematic device definition textual information.

4. The method of claim 3 wherein said preselected portion of said received metadata information further comprises mechanical simulation textual information.

5. A system which receives geometric and metadata information expressed in a computer aided design format and which allows at least some of the received metadata information to be displayed in a Portable Data format.

6. A system which receives geometric and metadata information expressed in a computer aided design format and which expresses the geometric information in a portable data format and which further displays a preselected amount of said received metadata information in said Portable Data Format.
